(19) United States
(12) Patent Application Publication
(10) Pub. No.: US 2020/0104174 A1
(43) Pub. Date: Apr. 2, 2020

(54) APPLICATION OF NATURAL LANGUAGE PROCESSING TECHNIQUES FOR PREDICTING RESOURCE CONSUMPTION IN A COMPUTING SYSTEM

(71) Applicant: CA, Inc., Islandia, NY (US)

(72) Inventors: Vitezslav Vit Vlcek, Prague (CZ); Premysl Zitka, Praha4 (CZ); Petr Vilcinsky, Prague (CZ); Maryna Pavlienova, Prague (CZ); Martin Strejc, Ricany (CZ)

(73) Assignee: CA, Inc., Islandia, NY (US)

(21) Appl. No.: 16/147,839

(22) Filed: Sep. 30, 2018

(51) Int. Cl. G06F 9/50; G06N 99/00

(52) U.S. Cl. CPC G06F 9/5011; G06N 99/005

(57) ABSTRACT

Embodiments include receiving a workload object that comprises program identifiers representing programs to be invoked in a particular order by a computing system, extracting the program identifiers from the workload object, and translating the program identifiers into respective predictions related to consumption of a resource by the programs corresponding to the program identifiers. The translating includes providing the program identifiers in the particular order as inputs to an encoder of a trained prediction model and generating, by a decoder of the trained prediction model, the predictions based, at least in part, on the particular order of the program identifiers.

### BACKGROUND

The present disclosure relates in general to the field of machine learning, and more specifically, to the application of natural language processing techniques for predicting resource consumption in a computing system.

Enterprises and other entities that rely on electronically stored information to conduct their business or other activities typically run workloads on computer systems according to a particular schedule to manage their electronically stored information. A workload can be defined by a set of programs running sequentially and/or in parallel during a particular time period. In many scenarios, these enterprises and other entities enter into a service level agreement (SLA) with a service provider to ensure that their workloads are completed according to schedule. When new programs are added to the existing set of programs, evaluations are needed to determine whether the computing system has sufficient resources to accommodate the new programs. Enterprises and other entities that run workloads to manage their electronically store information, in addition to service providers who manage the workloads, need techniques to more precisely and efficiently determine the impact of adding new programs to an existing workload on a computing system.

### BRIEF SUMMARY

According to one aspect of the present disclosure, a workload object is received and comprises program identifiers representing programs to be invoked in a particular order by a computing system. The program identifiers are extracted from the workload object. The program identifiers are translated into respective predictions related to consumption of a resource by the programs corresponding to the program identifiers. The translating may include providing the program identifiers in the particular order as inputs to an encoder of a trained prediction model and generating the predictions by a decoder of the trained prediction model. The predictions may be generated based, at least in part, on the particular order of the program identifiers.

### BRIEF DESCRIPTION OF THE DRAWINGS

FIG. 1 is a simplified schematic diagram of an example communication system for predicting resource consumption in a computing system using natural language processing techniques according to at least one embodiment.

FIG. 2 is a graph of the resource consumption of a central processing unit (CPU) over a period of time by an example workload running on a computing system.

FIG. 3 is a simplified block diagram illustrating additional details of certain components of the communication system according to at least one embodiment.

FIG. 4A is a simplified block diagram illustrating an example sequence-to-sequence model according to at least one embodiment.

FIG. 4B is an example unit in a recurrent neural network of the sequence-to-sequence model according to at least one embodiment.

FIG. 5 is a simplified block diagram illustrating example data and operation flow of the communication system according to at least one embodiment.

FIG. 6A is an example workload object to be translated into predictions of resource consumption on a computing system according to at least one embodiment.

FIG. 6B is a simplified block diagram of a prediction model translating program identifiers in the workload object of FIG. 6A, according to at least one embodiment.

FIG. 7A is another example workload object to be translated into predictions of resource consumption on a computing system according to at least one embodiment.

FIG. 7B is a simplified block diagram of a prediction model translating program identifiers with associated parameters in the workload object of FIG. 7A, according to at least one embodiment.

FIGS. 8A and 8B are simplified block diagrams illustrating the translation of example sequences of program identifiers in different orders of invocation, according to at least one embodiment.

FIG. 9 is a simplified flowchart illustrating possible operations associated with applying natural language processing techniques to predict resource consumption on a computing system according to at least one embodiment.

FIG. 10 is a simplified flowchart illustrating further possible operations associated with applying natural language processing techniques to predict resource consumption on a computing system according to at least one embodiment.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.), or combining software and hardware implementations that may all generally be referred to herein as a “circuit,” “module,” “component,” “model,” “monitor,” “trainer,” “extractor,” “parser,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but is not limited to, an electronic, magnetic, optical, electromagnetic, or semiconductor system, apparatus, or device, or any suitable combination of the foregoing. More specific examples (a non-exhaustive list) of the computer readable storage medium include the following: a portable computer diskette, a hard disk, a random access memory (RAM), a read-only memory (ROM), a programmable read-only memory (PROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (RF), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, low-level programming languages such as assembly languages, conventional procedural programming languages, such as the “C” programming language, Visual Basic, Fortran 2003, Perl, COBOL 2002, PHP, ABAP, dynamic or scripting programming languages such as Python, Ruby, Groovy, job control language (JCL), batch file (.BAT or .CMD), powershell file, REXX, or any format of data that can describe sequences (e.g., XML, JSON, YAML, etc.), or other programming languages. By way of example, the program code may execute entirely on a mainframe system, entirely on a local computer (e.g., server, server pool, desktop, laptop, etc.), partly on a mainframe system and partly on a local computer or remote computer (e.g., webserver), partly on the local computer and partly on a remote computer, entirely on a mainframe system, or entirely on a remote computer or server. In the scenarios involving a remote computer, the remote computer may be connected to a local computer or mainframe system through any type of network, including a local area network (LAN) or a wide area network (WAN), or the connection may be made to an external computer (for example, through the Internet using an Internet Service Provider) or in a cloud computing environment or offered as a service such as a Software as a Service (SaaS). Generally, any combination of a mainframe system, one or more local computers, and/or one or more remote computers may be utilized for executing the program code.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, can direct a computer, other programmable data processing apparatus, or other devices to function in a particular manner, such that the instructions when stored in the computer readable medium produce an article of manufacture including instructions that, when executed, cause a computer to implement the function/act specified in the flowchart and/or block diagram block or blocks and/or the function/act specified in the interactions of the block diagrams. The computer program instructions may also be loaded onto a computer, other programmable instruction execution apparatus, or other devices to cause a series of operations to be performed on the computer, other programmable apparatuses or other devices to produce a computer implemented process such that the instructions, which execute on the computer or other programmable apparatus provide processes for implementing the functions/acts specified in the flowchart and/or block diagram block or blocks and/or functions/acts specified in the interactions of the block diagrams.

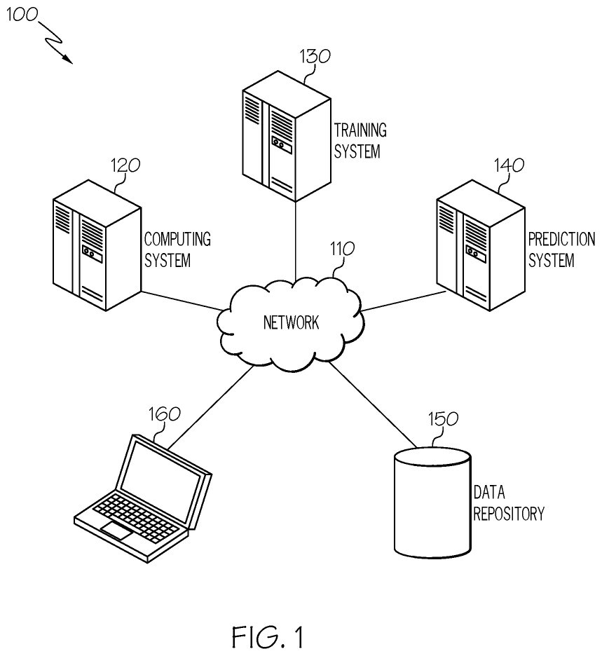

Referring now to FIG. 1, a simplified block diagram is shown illustrating an example communication system 100 for applying natural language processing techniques to predict resource consumption in a computing system according to at least one embodiment. Communication system 100 may include a computing system 120, a training system 130, and a prediction system 140. In at least one implementation, one or more networks such as network 110, may facilitate communication between computing system 120, training system 130, and prediction system 140, which may be provided as separate devices, virtualized systems, or other computing platforms. In some implementations, operations performed by computing system 120 and training system 130 may be integrated in a device, virtualized system, or other computing platform while prediction system 140 is provided separately in a local or remote network, for example. In other implementations, computing system 120, training system 130, and prediction system 140 may be combined in a device, virtualized system, or other computing platform. In one example, one or more of the components shown in FIG. 1 may be provided in a mainframe system in at least some implementations.

Communication system 100 may also include one or more user devices, such as user device 160, and one or more data repositories, such as a data repository 150. In one example, computing system 120 may use data repository 150 for storing electronic data needed to provide services or information to users via user devices, such as user device 160. One or more networks, such as network 110, may facilitate communications between user device 160, computing system 120 and data repository 150. In some implementations, however, a data repository may be integrated with computing system 120, for example, in a mainframe system.

In some scenarios, one or more existing workload objects may be scheduled for execution on computing system 120 to manage the computing system's stored electronic data (e.g., in data repository 150) and to perform other processing to enable computing system 120 to perform its services and/or other functions. Training system 130 may implement machine learning using natural language processing (NLP) techniques to train a prediction model to predict resource consumption by new workload objects to be executed on computing system 120. Training data that is used to train the prediction model may include historical data that has been captured during actual workloads running on computing system 120. Once the prediction model is trained, prediction system 140 may use the prediction model to translate program identifiers in a new workload object into predictions related to resource consumption by programs corresponding to the program identifiers. The predictions can be related to any resources from which consumption (or production) measurements can be obtained such as a central processor unit (CPU) and/or memory of the computing system.

For purposes of illustrating certain example techniques of communication system 100 for applying natural language processing techniques to predict resource consumption on a computing system, it is important to understand the activities that may be occurring in a network environment that includes a computing system, such as computing system 120. The following foundational information may be viewed as a basis from which the present disclosure may be properly explained.

Computing systems, such as computing system 120, may be used by enterprises and other entities to provide services and perform other functions to achieve their intended purposes (e.g., business, education, government, nonprofit, healthcare, etc.). A computing system may run certain workloads at different times of any given day. The term ‘workload’ generally refers to the amount of processing by a computing system at a particular time or during a particular time period. A ‘workload object’ may include one or more programs, or code to invoke one or more programs in a particular order. A workload object may be scheduled to run at a certain time on a computing system. The workload is the processing by the computing system during the execution of the workload object and the execution of the one or more programs. For example, a workload object may contain code to execute maintenance and other batch processing programs. The workload object may be scheduled to run between 2 am and 4 am each day. Therefore, the workload between 2 am-4 am can include the processing by the computing system during the execution of the maintenance and batch processing programs between 2 am and 4 am.

Entities often use internal or external service providers to manage workloads under a service level agreement (SLA) with particular turn-around times (TaT). When an entity is growing or otherwise changing, additional workloads may be desired and/or needed. Adding a new workload to be run during the same time frame as an existing workload, however, has the potential to affect the SLA of the existing workload. Furthermore, without adequate resources to accommodate the new workload, performance of the computing system could be negatively affected.

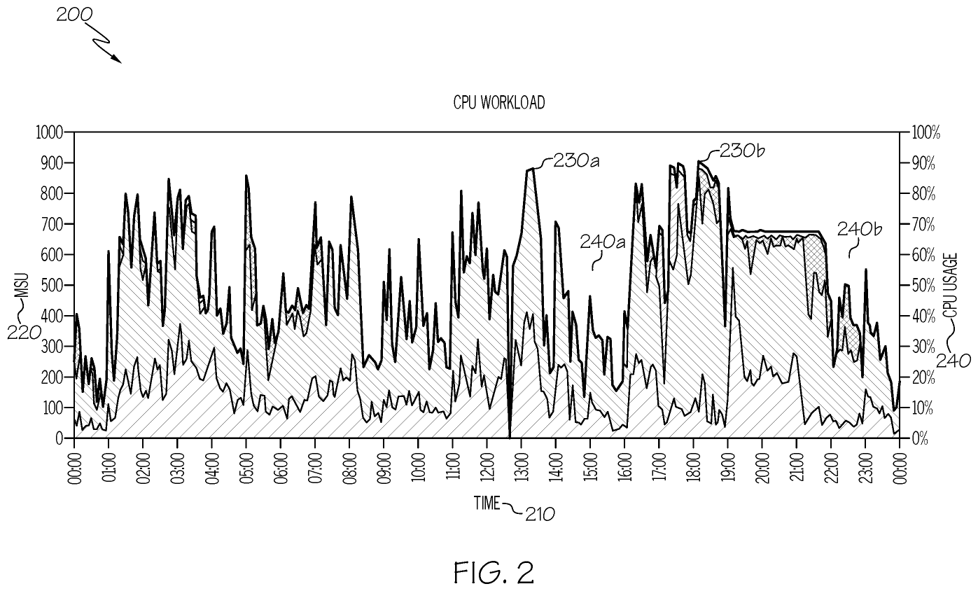

For illustration purposes, FIG. 2 is a graph 200 showing the resource consumption of MSU (million service units) 220 of a central processing unit (CPU) over a period of time 210 by an example existing workload running on the CPU. CPU usage 250 is CPU time measured as a percentage of the CPU's capacity. CPU usage peaks, such as 230a and 230b, indicate the current workload. CPU usage valleys, such as 240a and 240b, indicate intervals during the period of time 210 when the CPU is idling or there is minimal usage. To avoid causing performance issues and other problems, a new workload could be added to the existing workload at the CPU usage valleys, such as 240a and 240b. Whether the new workload can be successfully added, however, depends at least in part on the resource consumption (e.g., CPU time) of the new workload. If the new workload cannot fit within a valley, then depending on the particular implementation, new hardware or larger cloud accounts for the computing system may need to be acquired.

Current techniques for estimating resource consumption of new workloads is generally imprecise and inefficient. For example, historical data of programs included in a new workload may be used to estimate average resource consumption for a certain number of programs in a new workload. This process, however, may not consider the impact of various parameters, such as dataset allocation attributes or memory consumption, in the new workload. The process also may not consider the particular invocation sequence of the programs in the new workload to estimate the new workload's resource consumption. Moreover, new workload objects may invoke varying numbers of programs, which cannot typically be accommodated using current techniques to estimate resource consumption of a given workload object.

A communication system, such as communication system 100 shown for predicting resource consumption in a computing system using natural language processing techniques, as outlined in the FIGURES, can resolve these issues and others. Natural language processing (NLP) is a form of artificial intelligence that helps program computers to understand and interpret human languages. Certain NLP techniques can be used to translate one human language to another human language. Sequence-to-sequence learning is a form of machine learning that can be used to achieve certain NLP tasks, such as language translation. In at least one embodiment, sequence-to-sequence learning can be leveraged to train a prediction model to translate one or more program identifiers in a particular order to one or more respective predictions related to resource consumption on a computing system by one or more programs corresponding to the one or more program identifiers. Embodiments disclosed herein can include extracting program identifiers from a new workload object, providing the extracted program identifiers in a particular order (e.g., order of invocation by the new workload object) as inputs to a sequence-to-sequence prediction model to be translated to respective predictions related to resource consumption by programs corresponding to the program identifiers. Thus, the communication system can predict resource consumption of the new workload on the computing system by providing the extracted one or more program identifiers of the new workload object to the prediction model for translation.

Sequence-to-sequence learning can also be used to train the prediction model for a computing system based on historical data of workloads on the computing system. The historical data can include various sequences of one or more program identifiers, each in a particular order, corresponding to actual program executions and the resource consumption of the programs during the executions. In one embodiment, each sequence of one or more program identifiers may represent an actual execution of an existing workload object on the computing system. A sequence of program identifiers representing program executions and the corresponding sequence of resource consumption may be associated as an input-output sequence pair. Numerous input-output sequence pairs (e.g., hundreds, thousands, or more) can be used to train the prediction model.

In further embodiments, either the input or output of the prediction model (or both) could be extended by simply retraining the prediction model with appropriate input and output data. For example, in addition to program identifiers, the prediction model could also receive certain parameters as inputs such as dataset allocation attributes (e.g., size of files) indicated in the workload object, memory consumption indicated in the workload object, and/or actual size of datasets. These parameters could be used to extend the input to train the prediction model to translate program identifiers according to their associated parameters, if any. In a further example, the output could be extended by training the prediction model to translate each program identifier to a prediction range. A prediction range for a program identifier may include a range of resource consumption values such as a minimum, maximum, and average expected resource consumption (e.g., CPU time) of the program corresponding to the program identifier.

Embodiments of communication system 100 for predicting resource consumption on a computing system by applying natural language processing techniques can offer several advantages. Resource consumption predictions for new workloads on a computing system can be made efficiently and more precisely based on a large amount of historical data used to train a sequence-to-sequence prediction model. The prediction model can be trained based on many input sequences of program identifiers and corresponding output sequences of resource consumption values, where for each input sequence, the program identifiers are provided in the order in which they were invoked by an existing workload object. Thus, the prediction model can be trained to translate one or more program identifiers based on their particular order. To obtain more precise predictions, additional parameters can be considered along with program identifiers of the programs to be invoked by the workload object. Such parameters can include, but are not necessarily limited to, dataset allocation attributes, actual size of datasets, and/or memory consumption specified in the workload object. In addition, embodiments herein can provide more granular predictions by generating a prediction for each program in the workload. Furthermore, at least some embodiments offer a range of predictions related to resource consumption by each program.

Turning to FIG. 1, a brief description of the infrastructure of communication system 100 is now provided. Elements of FIG. 1 may be coupled to one another through one or more interfaces employing any suitable connections (wired or wireless), which provide viable pathways for network communications. Additionally, any one or more of these elements of FIG. 1 may be combined or removed from the architecture based on particular configuration needs.

Generally, communication system 100 can be implemented in any type or topology of networks. Within the context of the disclosure, network 110 represents a series of points or nodes of interconnected communication paths for receiving and transmitting packets of information that propagate through communication system 100. These networks offer communicative interfaces between sources, destinations, and intermediate nodes, and may include any local area network (LAN), virtual local area network (VLAN), wide area network (WAN) such as the Internet, wireless local area network (WLAN), metropolitan area network (MAN), Intranet, Extranet, virtual private network (VPN), and/or any other appropriate architecture or system that facilitates communications in a network environment or any suitable combination thereof. Network 110 can use any suitable technologies for communication including wireless (e.g., 3G/4G/5G/nG network, WiFi, Institute of Electrical and Electronics Engineers (IEEE) Std 802.11™-2012, published Mar. 29, 2012, WiMax, IEEE Std 802.16™-2012, published Aug. 17, 2012, Radio-frequency Identification (RFID), Near Field Communication (NFC), Bluetooth™, etc.) and/or wired (e.g., Ethernet, etc.) communication. Generally, any suitable means of communication may be used such as electric, sound, light, infrared, and/or radio (e.g., WiFi, Bluetooth, NFC, etc.).

In general, “servers,” “clients,” “computing devices,” “computing systems,” “data repositories,” “user devices,” “user terminals,” “systems,” etc. (e.g., 120, 130, 140, 150, 160, etc.) in example communication system 100, can include electronic computing devices operable to receive, transmit, process, store, or manage data and information associated with communication system 100. As used in this document, the term “computer,” “processor,” or “processor device,” is intended to encompass any suitable processing device. For example, elements shown as single devices within communication system 100 may be implemented using a plurality of computing devices and processors, such as server pools including multiple server computers. In some embodiments, one or more of the elements shown in FIG. 1 may be combined in a mainframe system. Further, any, all, or some of the computing devices may be adapted to execute any operating system, including IBM zOS, Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, computing devices, computing systems, data repositories, user devices, user terminals, systems, etc. (e.g., 120, 130, 140, 150, 160, etc.) can each include one or more processors, computer-readable memory, and one or more interfaces, among other features and hardware. Servers can include any suitable software component, manager, controller, or module, or computing device(s) capable of hosting and/or serving software applications and/or services, including distributed, enterprise, or cloud-based software applications, data, and services. For instance, in some implementations, computing system 120, training system 130, prediction system 140, data repository 150, or other sub-system of communication system 100, any or all of which may include one or more servers, can be at least partially (or wholly) cloud-implemented, web-based, or distributed to remotely host, serve, or otherwise manage data, software services and applications interfacing, coordinating with, dependent on, or used by other services, devices, and users (e.g., via network user terminals, other user terminals, etc.) in communication system 100. In some instances, a server, system, subsystem, computing device, etc. (e.g., 120, 130, 140, 150, 160) can be implemented as some combination of devices that can be hosted on a common mainframe system, computing system, server, server pool, or cloud computing environment and share computing resources, including shared memory, processors, and interfaces.

While FIG. 1 is described as containing or being associated with a plurality of elements, not all elements illustrated within communication system 100 of FIG. 1 may be utilized in each alternative implementation of the present disclosure. Additionally, one or more of the elements described in connection with the examples of FIG. 1 may be located external to communication system 100, while in other instances, certain elements may be included within or as a portion of one or more of the other described elements, as well as other elements not described in the illustrated implementation. Further, one or more elements illustrated in FIG. 1 may be combined with other components, as well as used for alternative or additional purposes in addition to those purposes described herein.

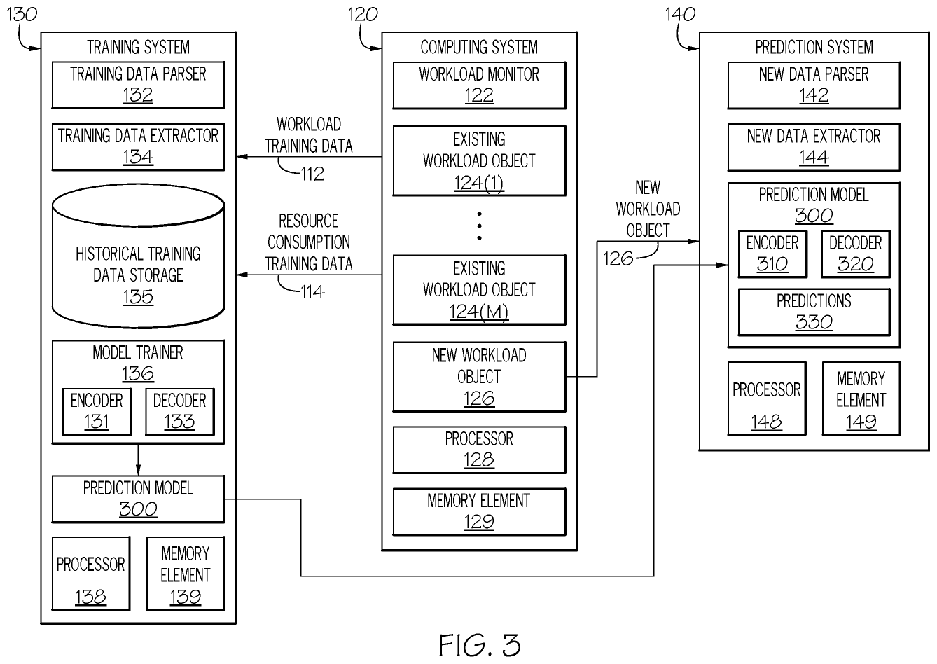

FIG. 3 is a simplified block diagram that illustrates additional possible details that may be associated with certain components of communication system 100. Specifically, computing system 120 may include a workload monitor 122, existing workload objects 124(1)-124(M), and a new workload object 126. Training system 130 may include a training data parser 132, a training data extractor 134, a model trainer 136, a prediction model 300, and historical training data storage 135. Prediction system 140 may include a new data parser 142, a new data extractor 144, and prediction model 300 received from training system 130. Prediction model 300 includes an encoder 310, a decoder 320, and predictions 330. Computing system 120, training system 130, and prediction system 140 may include appropriate hardware, including, but not necessarily limited to processors 128, 138, 148 and memory elements 129, 139, and 149.

Computing system 120 may include one or more existing workload objects 124(1)-124(M). Each existing workload object can include one or more programs or any suitable code for invoking one or more programs in a particular order on computing system 120. In one example, a workload object is encoded in a script language, which can be written to control the execution of one or more programs on a computing system. Examples of script languages in which a workload object could be encoded include, but are not limited to, job control language (JCL), Unix shell, AppleScript, batch file (e.g., .BAT or .CMD), powershell file, REXX, and any data format that can describe sequences (e.g., JSON, XML, YAML, etc.). In at least one implementation, one or more of the existing workload objects may be scheduled to run at a particular time of day on particular days (e.g., daily, every other day, weekly, monthly, etc.). When a workload object (e.g., 124(1)) is executed, workload monitor 122 can monitor the workload on the computing system and capture the resource consumption of any one or more resources during the execution of the programs invoked by the workload object.

Resources that may be monitored, and about which predictions can be made according to embodiments herein, can include anything that is measurable during the processing of a computer. For example, resources can include, but are not limited to one or more of a processor (e.g., CPU time), memory, disk space, network bandwidth, interrupt requests, system calls, energy, etc. In a distributed system or cluster, other resources include, but are not limited to a number of nodes required to process a workload, a number of racks required to process a workload, etc. In yet another example, predictions can be made as to a particular resource that is expected to be produced such as heat generation, which may be useful for determining cooling requirements for a computing system while a workload is running. Essentially, anything that can be measured during a particular time when a workload is running, could potentially be used to train a prediction model to predict consumption or production of that resource in accordance with one or more embodiments described herein.

Computing system 120 can provide workload training data 112 and corresponding resource consumption training data to training system 130. In at least one embodiment, workload training data 112 may include an existing workload object that was monitored during its execution by workload monitor 122. The existing workload object may comprise one or more program identifiers representing one or more programs invoked in a particular order. In some cases, the existing workload object may also contain parameters (e.g., dataset allocation attributes, actual dataset size, memory allocation, etc.) associated with one or more of the program identifiers in the existing workload object. Resource consumption training data 114 may include one or more captured values representing the resource consumption by each program that is executed by the existing workload object. The one or more captured values may be provided in sequence corresponding to the particular order of the program identifiers. Multiple sequences representing captured values from multiple executions of the existing workload object may be included in resource consumption training data 114. Workload training data 112 and resource consumption training data 114 may be provided separately or combined in a single file, table, or other data structure, where each program identifier in the existing workload object corresponds to a value indicating consumption of a resource by a program corresponding to that program identifier. In some implementations, the program identifiers and possibly associated parameters (e.g., dataset allocation attributes, actual dataset size, memory allocation) may be extracted from the workload object and then provided to training system 130 with corresponding resource consumption values.

Training system 130 may include training data parser 132 and training data extractor 134, in at least some implementations. For example, if workload training data 112 includes an existing workload object then the existing workload object may be parsed and the program identifiers (and possibly associated parameters) may be extracted from the object. The program identifiers and any associated parameters can be stored as an input sequence and the corresponding resource consumption values can be stored as an output sequence. The input sequence and output sequence can be associated as an input-output sequence pair. In at least one embodiment, the input-output sequence pair can be stored in historical training data storage 135.

Model trainer 136 is a machine learning module that can train prediction model 300 to translate one or more program identifiers in a particular order to one or more predictions related to resource consumption on a computing system (e.g., 120) by one or more programs corresponding to the one or more program identifiers. In at least one embodiment, natural language processing (NLP) techniques may be implemented to achieve the desired translation. One particular embodiment involves a sequence-to-sequence model with two recurrent neural networks (RNNs). The two RNNs in model trainer 136 can include an encoder 131 and a decoder 133. Sequence-to-sequence learning involves training models to convert sequences from one domain (e.g., program identifiers representing programs) to sequences in another domain (e.g., predictions related to resource consumption by the programs). Many samples of input-output sequence pairs (e.g., from historical training data storage 135) can be used to train the prediction model. During training, encoder 131 receives an input sequence of an input-output sequence pair, and the output of decoder 133 is set to the output sequence of the input-output sequence pair. Thus, based on processing many input-output sequence pairs, model trainer 136 can learn how to predict the output sequence based on the input sequence. In at least one embodiment, the model trainer itself is trained and prediction model 300 represents this trained model. Once the prediction model 300 is trained, it can be provided to prediction system 140.

Prediction system 140 is provisioned with prediction model 300, which is trained by training system 130, to make predictions based on input sequences of program identifiers and possibly additional parameters associated with one or more of the program identifiers. In an example scenario, a new workload object, such as new workload object 126, can be provided to prediction system 140 from computing system 120. The new workload object may be parsed by new data parser 142. One or more program identifiers (and possibly associated parameters) may be extracted from the object by new data extractor 144 as an input sequence of program identifiers. If certain parameters are associated with any program identifiers, in at least some implementations the parameters may also be extracted and may be placed in the input sequence after their associated program identifiers. In at least one embodiment, the program identifiers are extracted in the order in which programs corresponding to the program identifiers are to be invoked when the new workload object is executed. The one or more program identifiers (and any associated parameters) of the input sequence can be provided as inputs to encoder 310 of prediction model 300. The encoder can use a sequence of linear transformations to transform the input sequence into an array of numbers, referred to herein as a ‘thought vector.’ Decoder 320 interprets the thought vector to generate predictions 330, which can include a sequence of predictions, with one prediction (or a range of predictions) for each program identifier.

A prediction in predictions 330 can include a value (or values in some embodiments) representing consumption of a resource by a program corresponding to a program identifier in the input sequence of program identifiers extracted from a new workload object (e.g., 126). Prediction model 300 may be trained to predict the consumption of any number of different resources of computing system 120. Types of resource consumption include, but are not necessarily limited to, processor usage (e.g., CPU time), memory usage, disk space, network usage (e.g., network bandwidth for predicting how many packets or network flow is used by a program), interrupt requests, and system calls. In some embodiments, predictions can be extended to include, for example, a prediction range of resource consumption. For example, a prediction for a particular program could include a minimum expected resource consumption, a maximum expected resource consumption, and an average expected resource consumption. For example, a prediction range for CPU time could be: Minimum 10 μs, Average 200 μs, and Maximum 500 μs. Thus, the output can be extended to provide insight into the quality of predictions.

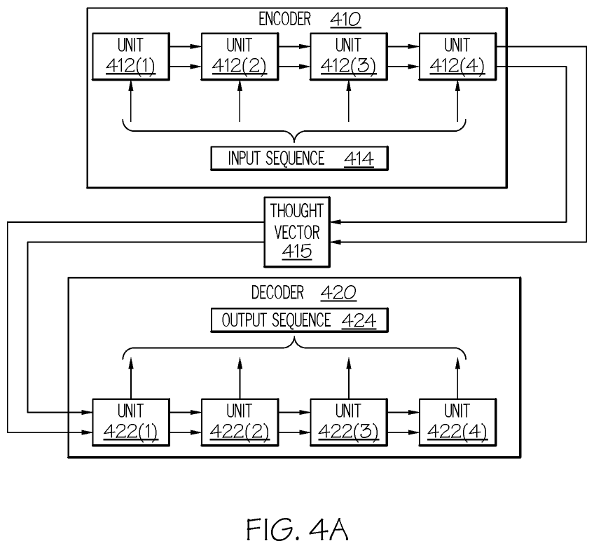

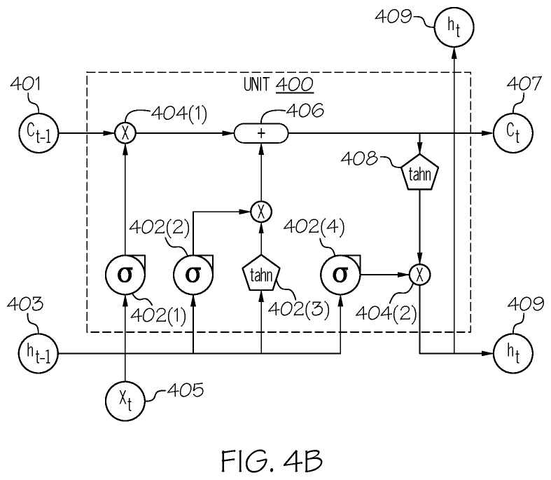

FIGS. 4A and 4B illustrate example components of a sequence-to-sequence model that uses recurrent neural networks for performing translations from one domain (e.g., program identifiers) to another domain (e.g., resource consumption predictions). A recurrent neural network is a type of artificial neural network (ANN), which uses a layered structure of algorithms that learn and recognize patterns from data representations. An ANN is based on a collection of connected units or nodes referred to as ‘neurons,’ which can compute values from inputs. ANNs have emerged as one of the most relevant and widespread techniques used for learning and recognizing patterns.

Various types of recurrent neural network (RNN) can be used for language translations in which a sequence of words in a first language is translated to a sequence of words in a second language. In at least one embodiment, this language translation model is extrapolated to embodiments disclosed herein to translate program identifiers in a new workload object to resource consumption values associated with programs corresponding to the program identifiers. Unlike traditional neural networks, RNNs perform the same task for every element in a sequence, but the output of the task is dependent on the previous computations. Simple RNNs may only consider the most recent previous computations. Some translations, however, may not be accurate without additional context. Accordingly, specific RNN architectures have been developed to offer more accurate translations of sequences with long-term dependencies.

In one example, Long short-term memory (LSTM) is a particular type of RNN architecture that can accommodate temporal sequences and learn their long-range dependencies in a more accurate manner than traditional RNNs. LSTMs are typically implemented in blocks, such as an encoder 410 and a decoder 420 shown in FIG. 4A. Each block can contain several units, such as units 412(1), 412(2), 412(3), and 412(4) shown in encoder 410 and units 422(1), 422(2), 422(3), and 422(4) shown in decoder 420. Each unit may perform a linear transformation and/or activation on input data received by that unit and may provide output data based on the transformation and/or activation.

In encoder 410, an input sequence of elements 414 to be translated can be received by units 412(1)-412(4). In at least one embodiment, each unit receives a different element in the sequence, and the elements are received in sequential order. For example, unit 412(1) receives the first element in the sequence, unit 412(2) receives the second element in the sequence, and so on. Each unit provides its output as input to the next unit. For example, the output of unit 412(1) is provided as input to unit 412(2), the output of unit 412(2) is provided as input to unit 412(3), and so on. The last unit 412(4) provides the output to a thought vector 415, which is an array of numbers based on the sequence of linear transformations and activations in the encoder, and which represents the sequence of elements to be translated.

Decoder 420 receives the thought vector as input and performs a sequence of linear transformations and activations to produce an output sequence of values 424 comprising a translation result from each unit. The translation results from units 422(1)-422(4) can correspond respectively to elements in the input sequence to be translated. For example, the translation result from unit 422(1) corresponds to the input element of unit 412(1), the translation result from unit 422(2) corresponds to the input element of unit 412(2), and so on. Each unit also provides its output as input to the next unit. For example, the output of unit 422(1) is provided as input to unit 422(2), the output of unit 422(2) is provided as input to unit 422(3), and so on.

Although LSTM units may have slight variations depending on the particular use and implementation, one possible LSTM configuration will now be described for illustration purposes. With reference to FIG. 4B, an example LSTM unit 400 having four neural network layers 402(1), 402(2), 402(3), and 402(4) is illustrated. An input cell state Cₜ₋₁ from the prior unit is received at 401, and after some interactions within unit 400, a resulting cell state Cₜ for unit 400 is output at 407. The neural network layers 402(1), 402(2), and 402(4) are sigmoid layers that produce output numbers between zero and one to control the cell state.

The first neural network layer 402(1) receives an output value hₜ₋₁ at 403 from the prior unit and an input value xₜ at 405. In the encoder, the input value xₜ may be an element in the input sequence to be translated. In the decoder, the input value xₜ may be a portion of the thought vector. Neural network layer 402(1) is a ‘forget gate’ layer and outputs a number between 0 and 1 based on the prior cell's output value hₜ₋₁ and the input value xₜ. A number between 0 and 1 is output for each number in the input cell state Cₜ₋₁. A zero removes a number in a cell state, while a 1 leaves the number in the cell state. The input cell state is updated by multiplication at 404(1).

Neural network layers 402(2) and 402(3) determine new information to be stored in the resulting cell state Cₜ. Neural network layer 402(2) performs a sigmoid function that decides which values in the cell state are to be updated. Neural network layer 402(3) performs a tanh function and creates a vector of new values that could be added to the cell state. At 406, the resulting cell state Cₜ is created by adding new values, generated from the neural network layers 402(2) and 402(3), to the updated input cell state.

The output of the unit is based on the resulting cell state Cₜ. The last neural network layer 402(4) determines what part of the resulting cell state Cₜ will be included in a unit output hₜ. A tanh function is applied to the resulting cell state Cₜ at 408. The unit output hₜ is generated by multiplying, at 404(2), the values output from the tanh function and the output of the sigmoid neural network layer 402(4). The resulting cell state Cₜ and the unit output hₜ can be provided as input to the next unit. In a decoder, however, the unit output hₜ is the prediction for sequence element received as input by a unit in the encoder that corresponds to the unit that produced the unit output hₜ.

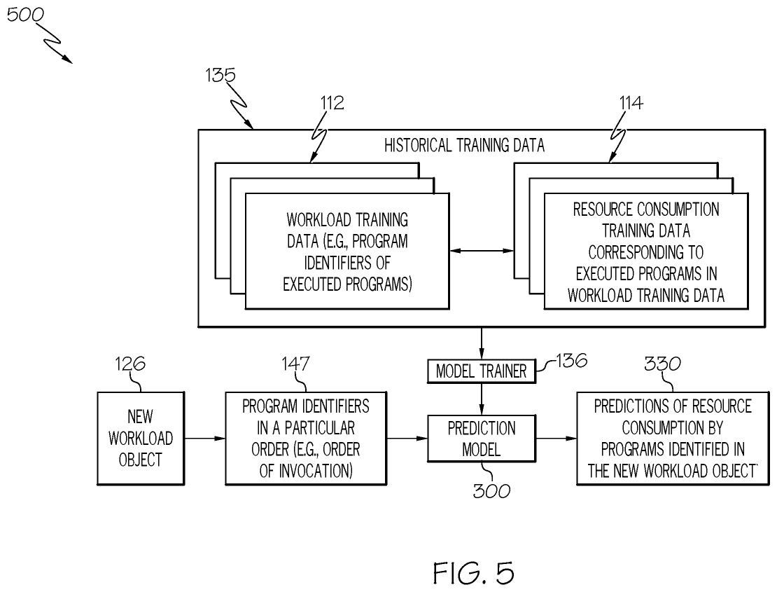

Turning to FIG. 5, a simplified block diagram illustrates an example of data and operation flow 500 of a communication system, such as communication system 100, for predicting resource consumption in a computing system using natural language processing techniques. Historical training data in historical training data storage 135 may include corresponding input and output sequences of training data (or input-output sequence pair). This training data may be derived from an existing workload object and multiple actual executions of the existing workload object on a computing system (e.g., 120). Workload training data 112 can include input sequences of program identifiers of executed programs. For each input sequence, the program identifiers may be arranged in an order of invocation of programs corresponding to the program identifiers by an existing workload object. The order of invocation may be ascertained based on the existing workload object. In at least one embodiment, the program identifiers can be extracted from the existing workload object in the order of invocation by a parser (e.g., 132) and an extractor (e.g., 134). In some embodiments, one or more parameters specified in the existing workload object may also be extracted for the input sequence in the workload training data 112.

The program identifiers and any associated parameters can be stored as an input sequence and the corresponding actual resource consumption values can be stored as an output sequence. The input sequence and output sequence can be associated as an input-output sequence pair. In at least one embodiment, the input-output sequence pair can be stored in historical training data storage 135.

Resource consumption training data 114 can include an output sequence of values representing consumption of a particular resource and corresponding to the sequence of program identifiers. The output sequence of values may be actual resource consumption values captured during an execution of the existing workload object. Multiple sets of workload training data 112 and resource consumption training data 114 may be provided for a computing system. Moreover, the workload training data and corresponding resource consumption training data may be used to train the prediction model using captured resource consumption values for multiple existing workload objects that have been executed on the computing system.

Model trainer 136 may be a sequence-to-sequence untrained model based on a particular RNN architecture such as, for example LSTM or gated recurrent unit (GRU). It should be apparent, however, that other types of RNN architectures could be used based on particular needs and implementations to translate program identifiers to predictions related to resource consumption. The model trainer 136 learns the translation based on using the workload training data 112 as input to encoder 131 and resource consumption training data 114 as output of decoder 133. The resulting prediction model 300 can perform the translations based on an input sequence of program identifiers.

Once the prediction model 300 is trained, it can be used to predict resource consumption of a new workload object, such as new workload object 126, for the computing system. The new workload object may be parsed and program identifiers in the new workload object can be extracted and put in a particular order (e.g., invocation order or any other desired order). The one or more extracted program identifiers can be provided as inputs to prediction model 300. An encoder of the prediction model can receive each program identifier (and each parameter, if any) as an input to a respective unit, such that the respective units process the program identifiers in the particular order. A vector output from the encoder (e.g., thought vector) can be consumed by a decoder to generate predictions related to consumption of a resource by the programs corresponding to the program identifiers.

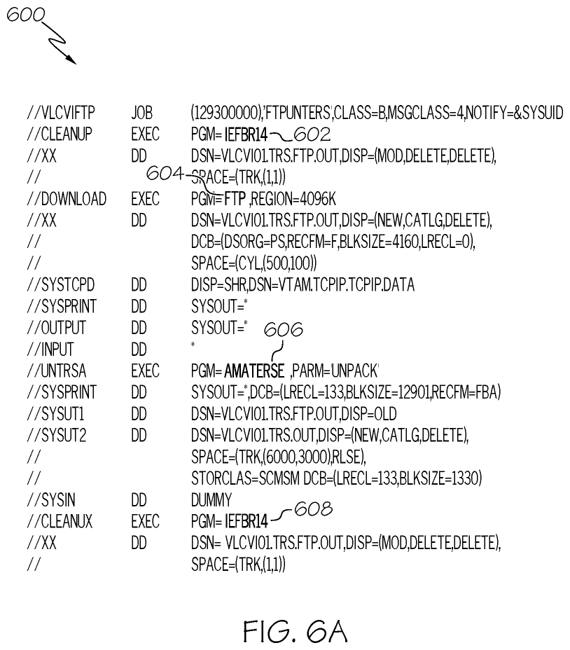

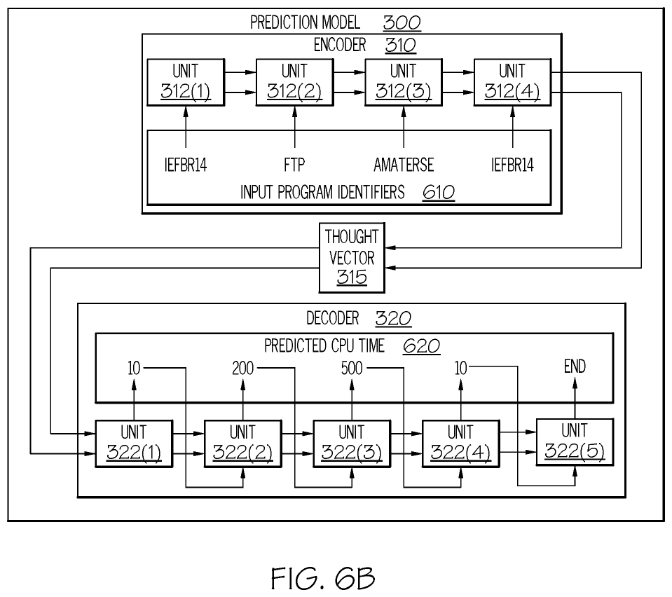

Turning to FIGS. 6A-6B, an example scenario of a new workload object and the translation of program identifiers in the new workload object to predictions of resource consumption by a trained sequence-to-sequence prediction model is illustrated. FIG. 6A illustrates an example new workload object in the form of a job control language (JCL) script 600 that is to be run on a computing system (e.g., 120). JCL script 600 invokes four programs represented by program identifiers, which include IEFBR14 602, FTP 604, AMATERSE 606, and IEFBR14 608. IEFBR14 602 performs a cleanup, FTP 604 performs a file download, AMATERSE 606 unpacks a dataset associated with the file download, and IEFBR14 608 performs another cleanup. The program identifiers in JCL script 600 are extracted and put in the following input sequence: (IEFBR14, FTP, AMATERSE, IEFBR14). In one or more embodiments, the input sequence is the order of invocation in JCL script 600.

FIG. 6B illustrates the translation of the input sequence of program identifiers 610 by the sequence-to-sequence prediction model 300 to predictions related to CPU consumption. The input sequence of program identifiers 610 is provided as input to encoder 310. Each program identifier is input for a respective unit 312(1)-312(4) of encoder 310. The units process the program identifiers in the same order as the input sequence of the program identifiers (e.g., order of invocation in the JCL script). Unit 312(1) receives IEFBR14 as input and generates a cell state and an output value that are provided to unit 312(2). Unit 312(2) receives FTP and the outputs from unit 312(1) as input and generates a cell state and an output value that are provided to unit 312(3). Unit 312(3) receives AMATERSE and the outputs from unit 312(2) and generates a cell state and an output value that are provided as input to unit 312(4). Unit 312(4) receives IEFBR14 and the outputs from unit 312(3) and generates a cell state and an output value as thought vector 315.

Thought vector 315 is provided as input to decoder 320. Units 322(1)-322(5) generate predictions of CPU consumption based on thought vector 315. The predictions may be an output sequence of predicted CPU time 620, in one example. Units 322(1)-322(4) correspond to the input sequence of program identifiers 610. Unit 322(1) corresponds to the first occurrence of IEFBR14, unit 322(2) corresponds to FTP, unit 322(3) corresponds to AMATERSE, and unit 322(4) corresponds to the second occurrence of IEFBR14. Unit 322(1) receives thought vector 315 as input and generates a prediction of 10 μs of CPU time for the first occurrence of IEFBR14 (i.e., 602). Unit 322(2) receives a cell state and the 10 μs prediction from unit 322(1) as input and generates a prediction of 200 μs of CPU time for FTP (i.e., 604). Unit 322(3) receives a cell state and the 200 μs prediction from unit 322(2) as input and generates a prediction of 500 μs of CPU time for AMATERSE (i.e., 606). Unit 322(4) receives a cell state and the 500 μs prediction from unit 322(3) as input and generates a prediction of 10 μs of CPU time for the second occurrence of IEFBR14 (i.e., 608). Unit 322(5) receives a cell state and the 10 μs prediction from unit 322(4) as input and ends the processing. Accordingly, the input sequence of program identifiers (IEFBR14, FTP, AMATERSE, IEFBR14) is translated to an output sequence of predictions (10 μs, 200 μs, 500 μs, 10 μs) of the CPU time consumed by the programs when executed by the JCL script 600.

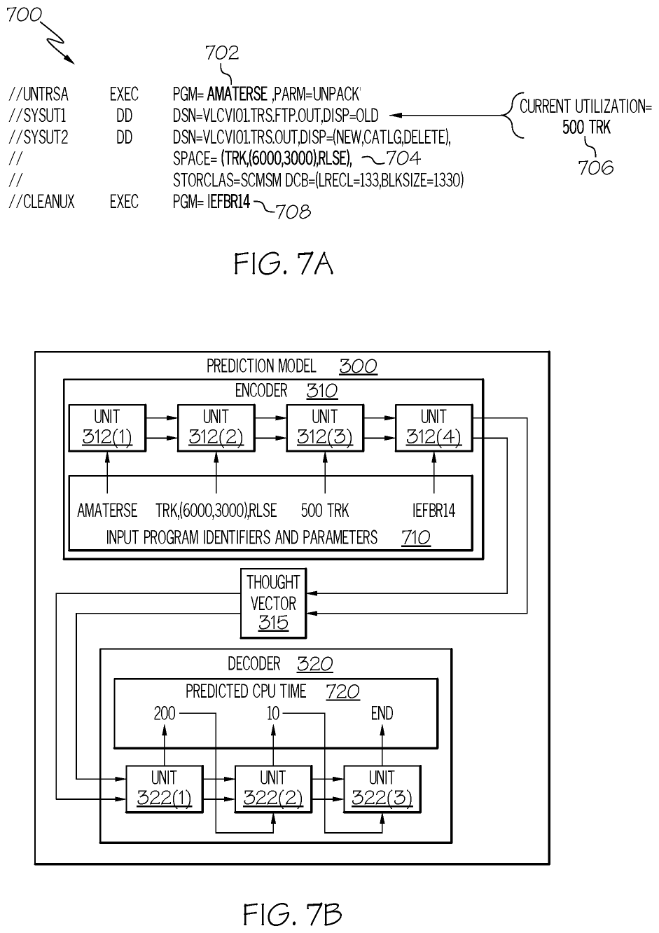

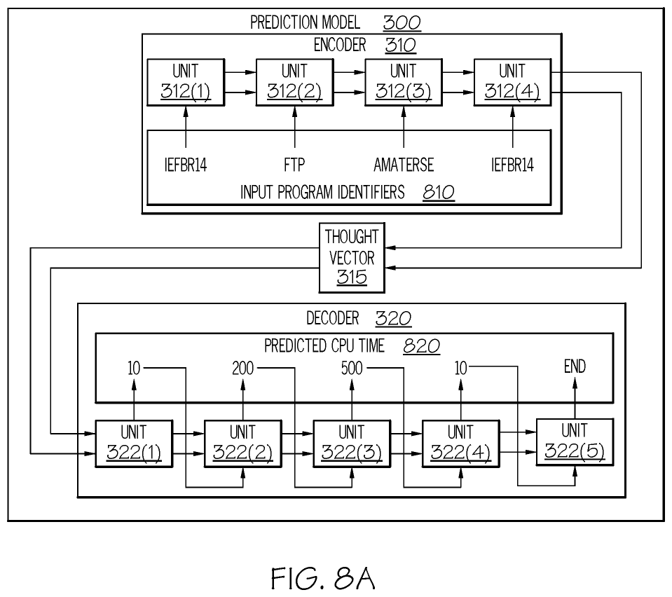

Turning to FIGS. 7A-7B, an example scenario of a new workload object and the translation of program identifiers with extended input in the new workload object to predictions of resource consumption by a trained sequence-to-sequence prediction model is illustrated. FIG. 7A illustrates an example new workload object in the form of a job control language (JCL) script 700 that is to be run on a computing system (e.g., 120). JCL script 700 invokes two programs corresponding to program identifiers that include AMATERSE 702 and IEFBR14 708.

JCL script 700 also includes extended input that may be extracted and used in the translation to provide context for a more precise prediction. In JCL script 700, the extended input is in the form of parameters related to datasets. For example, a first dataset identified in the JCL script is SYSUT1, which has a current size of 500 tracks (TRK) on the hard drive as indicated at 706. A second dataset may be allocated using a size of TRK, (6000,3000), RLSE as indicated at 704. Accordingly, the program identifiers and parameters in JCL script 600 can be extracted and put in the following input sequence: (AMATERSE, TRK, (6000,3000), RLSE, 500 TRK, IEFBR14). In one or more embodiments, the input sequence of the program identifiers is the order of invocation in JCL script 700. In this scenario, a computing system where the new workload object is to run may be queried to determine the current utilization of the first dataset SYSUT1. Because the dataset is already allocated, the size may not be included in the new workload object. Thus, the extraction may need to be formed on the computing system or in coordination with the computing system in order to obtain the current allocation information of SYSUT1 for this implementation.

FIG. 7B illustrates the translation of the input sequence of program identifiers and parameters 710 by the sequence-to-sequence prediction model 300 to predictions related to CPU consumption. The input sequence of program identifiers and parameters 710 is provided as input to encoder 310. Each program identifier and each parameter are input for a respective unit 312(1)-312(4) of encoder 310. The units process the program identifiers and parameters in the same order as the input sequence of the program identifiers and parameters. Unit 312(1) receives AMATERSE as input and generates a cell state and an output value that are provided to unit 312(2). Unit 312(2) receives parameter TRK, (6000,3000), RLSE and the outputs from unit 312(1) as input and generates a cell state and an output value that are provided to unit 312(3). Unit 312(3) receives parameter 500 TRK and the outputs from unit 312(2) and generates a cell state and an output value that are provided as input to unit 312(4). Unit 312(4) receives IEFBR14 and the outputs from unit 312(3) and generates a cell state and an output value as thought vector 315.

Thought vector 315 is provided as input to decoder 320. Units 322(1)-322(3) generate predictions of CPU consumption based on thought vector 315. The predictions may be an output sequence of predicted CPU time 720, in one example. Units 322(1)-322(2) correspond to the input sequence of program identifiers. Unit 322(1) corresponds to AMATERSE and unit 322(2) corresponds to IEFBR14. Decoder units are not provided for the parameter input data, because the parameters provide additional context to enable a more precise prediction for the program associated with the parameters. Unit 322(1) receives thought vector 315 as input and generates a prediction of 200 μs of CPU time for AMATERSE (i.e., 702). Unit 322(2) receives a cell state and the 200 μs prediction from unit 322(1) as input and generates a prediction of 10 μs of CPU time for IEFBR14 (i.e., 708). Unit 322(3) receives a cell state and the 10 μs prediction from unit 322(2) as input and ends the processing. Accordingly, the input sequence of program identifiers and parameters (AMATERSE, IEFBR14) is translated to an output sequence of predictions (200 μs, 10 μs) of the CPU time expected to be consumed by the programs when executed by the JCL script 700.

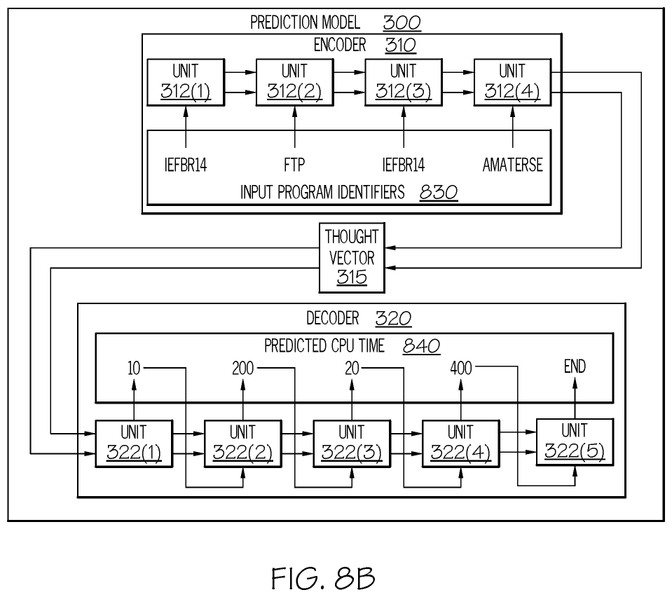

Turning to FIGS. 8A-8B, FIGS. 8A and 8B illustrate translations by prediction model 300 of different example input sequences of the same program identifiers to different example output sequences of predictions related to CPU consumption. FIG. 8A illustrates the translation of a plurality of program identifiers with the program identifiers arranged in a first input sequence. FIG. 8B illustrates the translation of the plurality of program identifiers with the program identifiers arranged in a second input sequence. In at least one embodiment, the first input sequence represents a particular invocation order of programs corresponding to the program identifiers and the second input sequence represent a different invocation order of the programs corresponding to the program identifiers. Also, it should be noted that while the example in FIGS. 8A and 8B contain only program identifiers in the input sequences, parameters in addition to program identifiers may also be contained in the input sequences in at least some implementations.

In FIG. 8A, program identifiers 810 in a first input sequence are arranged in the following order: (IEFBR14, FTP, AMATERSE, IEFBR14). The first input sequence of program identifiers 810 is provided as input to encoder 310. Each program identifier is input for a respective unit 312(1)-312(4) of encoder 310. The units process the program identifiers in the same order as the first input sequence of the program identifiers. Unit 312(1) receives IEFBR14 as input and generates a cell state and an output value that are provided to unit 312(2). Unit 312(2) receives FTP and the outputs from unit 312(1) as input and generates a cell state and an output value that are provided to unit 312(3). Unit 312(3) receives AMATERSE and the outputs from unit 312(2) and generates a cell state and an output value that are provided as input to unit 312(4). Unit 312(4) receives IEFBR14 and the outputs from unit 312(3) and generates a cell state and an output value as thought vector 315.

Thought vector 315 is provided as input to decoder 320. Units 322(1)-322(5) generate predictions of CPU consumption (e.g., predicted CPU time) based on thought vector 315. The predictions may be a first output sequence of predicted CPU time 820, in one example. Units 322(1)-322(4) correspond to the first input sequence of program identifiers 810. Unit 322(1) corresponds to the first occurrence of IEFBR14, unit 322(2) corresponds to FTP, unit 322(3) corresponds to AMATERSE, and unit 322(4) corresponds to the second occurrence of IEFBR14. Unit 322(1) receives thought vector 315 as input and generates a prediction of 10 μs of CPU time for the first occurrence of IEFBR14. Unit 322(2) receives a cell state and the 10 μs prediction from unit 322(1) as input and generates a prediction of 200 μs of CPU time for FTP. Unit 322(3) receives a cell state and the 200 μs prediction from unit 322(2) as input and generates a prediction of 500 μs of CPU time for AMATERSE. Unit 322(4) receives a cell state and the 500 μs prediction from unit 322(3) as input and generates a prediction of 10 μs of CPU time for the second occurrence of IEFBR14. Unit 322(5) receives a cell state and the 10 μs prediction from unit 322(4) as input and ends the processing. Accordingly, the first input sequence of program identifiers (IEFBR14, FTP, AMATERSE, IEFBR14) is translated to a first output sequence of predictions (10 μs, 200 μs, 500 μs, 10 μs) of the CPU time to be consumed by the programs when invoked in the order of the first input sequence.

In FIG. 8B, program identifiers 830 in a second input sequence are arranged in the following order: (IEFBR14, FTP, IEFBR14, AMATERSE), which varies from the order of the first input sequence of program identifiers 810 in FIG. 8A. The second input sequence of program identifiers 830 is provided as input to encoder 310. Each program identifier is input for a respective unit 312(1)-312(4) of encoder 310. The units process the program identifiers in the same order as the second input sequence of the program identifiers. Unit 312(1) receives IEFBR14 as input and generates a cell state and an output value that are provided to unit 312(2). Unit 312(2) receives FTP and the outputs from unit 312(1) as input and generates a cell state and an output value that are provided to unit 312(3). Unit 312(3) receives IEFBR14 and the outputs from unit 312(2) and generates a cell state and an output value that are provided as input to unit 312(4). Unit 312(4) receives AMATERSE and the outputs from unit 312(3) and generates a cell state and an output value as thought vector 315.

Thought vector 315 is provided as input to decoder 320. Units 322(1)-322(5) generate predictions of CPU consumption (e.g., predicted CPU time) based on thought vector 315. The predictions may be a second output sequence of predicted CPU time 840, in one example. Units 322(1)-322(4) correspond to the second input sequence of program identifiers 830. Unit 322(1) corresponds to the first occurrence of IEFBR14, unit 322(2) corresponds to FTP, unit 322(3) corresponds to the second occurrence of IEFBR14, and unit 322(4) corresponds to AMATERSE. Unit 322(1) receives thought vector 315 as input and generates a prediction of 10 μs of CPU time for the first occurrence of IEFBR14. Unit 322(2) receives a cell state and the 10 μs prediction from unit 322(1) as input and generates a prediction of 200 μs of CPU time for FTP. Unit 322(3) receives a cell state and the 200 μs prediction from unit 322(2) as input and generates a prediction of 20 μs of CPU time for the second occurrence of IEFBR14. Unit 322(4) receives a cell state and the 20 μs prediction from unit 322(3) as input and generates a prediction of 400 μs of CPU time for AMATERSE. Unit 322(5) receives a cell state and the 400 μs prediction from unit 322(4) as input and ends the processing. Accordingly, the second input sequence of program identifiers (IEFBR14, FTP, IEFBR14, AMATERSE) is translated to a second output sequence of predictions (10 μs, 200 μs, 20 μs, 400 μs) of the CPU time to be consumed by the programs when invoked in the order of the second input sequence.

It should be noted that although the first input sequence of program identifiers and the second input sequence of program identifiers included the same program identifiers, albeit in different orders, the outputs from the encoder did not result in one-to-one correspondence of predicted CPU time for each program identifier. For example, the predicted CPU time of AMATERSE in FIG. 8A is 500 μs, while the predicted CPU time of AMATERSE in FIG. 8B is 400 μs. The predicted CPU time of the second occurrence of IEFBR14 in FIG. 8A is 10 μs, while the predicted CPU time of the second occurrence of IEFBR14 in FIG. 8B is 20 μs. Thus, the predictions can depend on the particular order of program identifiers (and parameters, if any) in the input sequence.

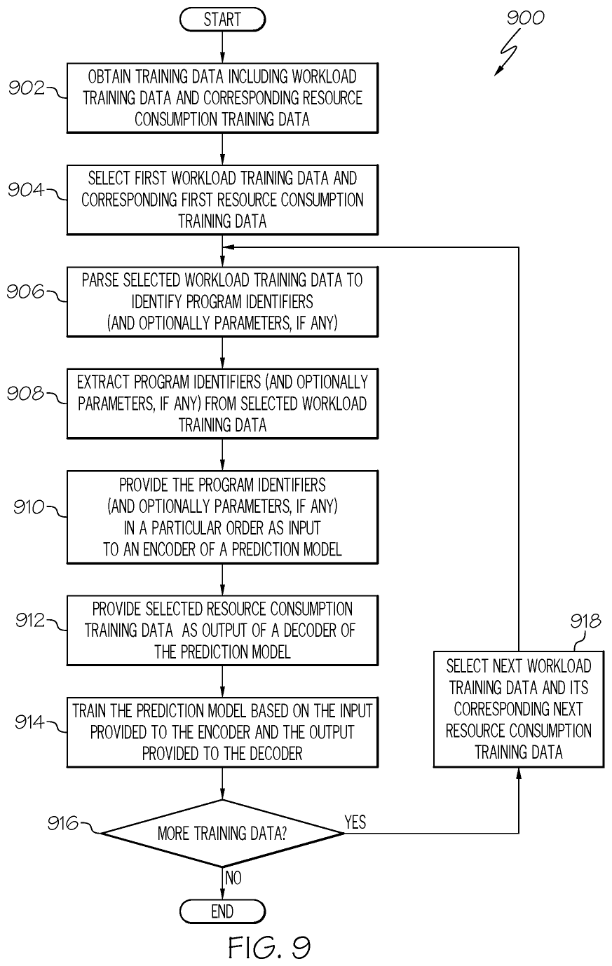

FIG. 9 is a simplified flowchart 900 illustrating an example flow that may be associated with embodiments described herein. In at least one embodiment, one or more operations correspond to activities of FIG. 9. In one example, a training system (e.g., 130), or a portion thereof, may perform at least some of the one or more operations. The training system may comprise means, such as processor 138 and memory element 139, for performing the operations. In an embodiment, one or more operations of flowchart 900 may be performed by a training data parser (e.g., 132), a training data extractor (e.g., 134), and/or a model trainer (e.g., 136).

At 902, training data that includes workload training data and corresponding resource consumption training data is obtained. At 904, first workload training data and corresponding first resource consumption training data are selected. At 906, the selected workload training data may be parsed to identify program identifiers and possibly other parameters. Examples of parameters that may be identified include, but are not necessarily limited to, dataset allocation attributes (e.g., SPACE=TRK,(1,1)), memory consumption (e.g., REGION=4096K, etc.). Some parameters may be obtained from the computing system from which the training data was obtained. For example, the actual size of a dataset that is used in a workload object from which the training data is derived, may be obtained from the memory or storage of the computing system on which the workload object is executed. At 908, the identified program identifiers (and parameters, if any) can be extracted from the selected workload training data.

At 910, the program identifiers (and parameters, if any) can be provided as input to an encoder of a model trainer in a particular order or sequence, such as the order of invocation in the workload object. At 912, values in the selected resource consumption training data can be provided as output of a decoder of the model trainer in a particular order or sequence that corresponds to the order of the program identifiers. For example, if program identifier A (representing program A) is the third program identifier in the input sequence of program identifiers, then a value from the resource consumption training data that indicates the resource consumption of program A is the third value in the output sequence of values representing the resource consumption of programs.

At 914, the model trainer uses sequence-to-sequence learning to train a prediction model to translate an input sequence of program identifiers (and possibly parameters, if any) having a particular order to an output sequence of predictions related to resource consumption of programs corresponding to the program identifiers. The learning is based on the input sequence provided to the encoder and the output sequence provided to the decoder in addition to many other instances of input sequences and corresponding output sequences in the training data.

At 916, a determination may be made as to whether more training data is available. If more training data is available, then at 918, the next workload training data and its corresponding resource consumption training data is selected. Flow passes to 906 and continues the sequence-to-sequence learning until no more training data is available as determined at 916. In one or more embodiments, the greater the number of input sequences and corresponding output sequences that are used to train the prediction model, the more precise the predictions based on new workload objects may be.

Once there is no more training data available, as determined at 916, the flow may end.

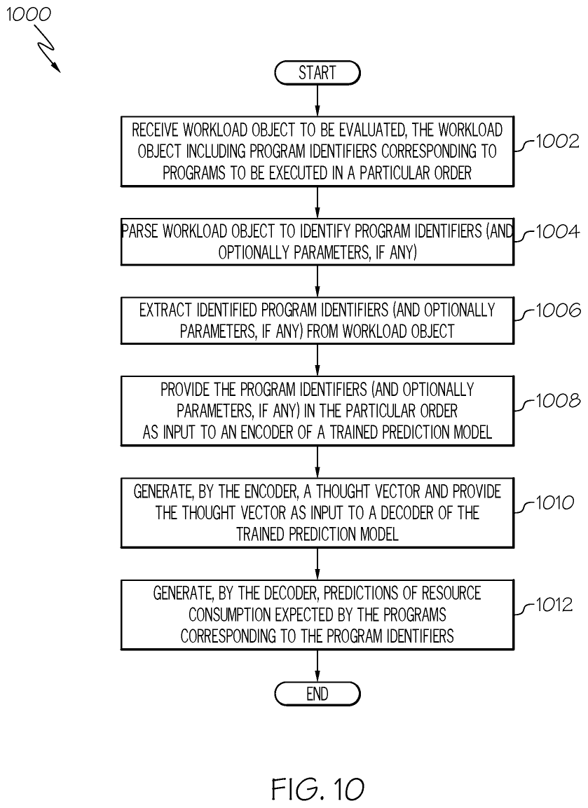

FIG. 10 is a simplified flowchart 1000 illustrating an example flow that may be associated with embodiments described herein. In at least one embodiment, one or more operations correspond to activities of FIG. 10. In one example, a prediction system (e.g., 140), or a portion thereof, may perform at least some of the one or more operations. The training system may comprise means, such as processor 148 and memory 149, for performing the operations. In an embodiment, one or more operations of flowchart 1000 may be performed by a new data parser (e.g., 142), a new data extractor (e.g., 144), and/or a prediction model (e.g., 300).

At 1002, a workload object to be evaluated is received. In some scenarios, the workload object may be new and may not have been run on the computing system. The workload object includes program identifiers corresponding to programs to be invoked in a particular order. The workload object may also include parameters associated with one or more of the program identifiers.

At 1004, the workload object can be parsed to identify program identifiers and optionally, parameters if any. At 1006, the program identifiers and optionally parameters, if any, can be extracted from the workload object.

At 1008, the program identifiers (and parameters, if any) can be provided as input to an encoder of a trained prediction model in a particular order or sequence. At 1010, the encoder generates a thought vector by performing linear transformations and activations based on the input sequence of the program identifiers and possibly one or more parameters.

At 1012, the decoder generates predictions of resource consumption expected by programs corresponding to the program identifiers in the input sequence. Examples of the types of resources for which predictions may be generated include, but are not necessarily limited to, processor, memory, disk space, network bandwidth, interrupt requests, system calls, energy consumption, heat generation (e.g., to predict needed cooling requirements), etc. In a distributed system or cluster, other examples include, but are not limited to a number of nodes that will be required to process a workload, a number of racks needed to process a workload, etc. Essentially, anything that can be measured during a particular time when a workload is running, could potentially be predicted based on a sequence of program identifiers in a particular order to be invoked according to embodiments described herein.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that all variations of the terms “comprise,” “include,” and “contain,” when used in this specification, specify the presence of stated features, integers, steps, operations, elements, and/or components, but do not preclude the presence or addition of one or more other features, integers, steps, operations, elements, components, and/or groups thereof.

As used herein, unless expressly stated to the contrary, use of the phrase ‘at least one of’ or ‘one or more of’ refers to any combination of the named elements, conditions, or activities. For example, ‘at least one of X, Y, and Z’ is intended to mean any of the following: 1) at least one X, but not Y and not Z; 2) at least one Y, but not X and not Z; 3) at least one Z, but not X and not Y; 4) at least one X and at least one Y, but not Z; 5) at least one X and at least one Z, but not Y; 6) at least one Y and at least one Z, but not X; or 7) at least one X, at least one Y, and at least one Z. Also, unless expressly stated to the contrary, the terms ‘first’, ‘second’, ‘third’, etc., are intended to distinguish the particular noun (e.g., element, condition, module, activity, operation, claim element, etc.) they modify, but are not intended to indicate any type of order, rank, importance, temporal sequence, or hierarchy of the modified noun. For example, ‘first X’ and ‘second X’ are intended to designate two separate X elements, that are not necessarily limited by any order, rank, importance, temporal sequence, or hierarchy of the two elements.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
receiving a workload object, wherein the workload object comprises program identifiers representing programs to be invoked in a particular order by a computing system;
extracting the program identifiers from the workload object; and
translating the program identifiers into respective predictions related to consumption of a resource by the programs corresponding to the program identifiers, wherein the translating includes:
providing the program identifiers in the particular order as inputs to an encoder of a trained prediction model; and
generating, by a decoder of the trained prediction model, the predictions based, at least in part, on the particular order of the program identifiers.

2. The method of claim 1, wherein the workload object is encoded in a script programming language.

3. The method of claim 1, further comprising:
parsing the workload object to identify the program identifiers.

4. The method of claim 1, wherein a first prediction for a first program represented by a first program identifier extracted from the workload object indicates an amount of process time, memory usage, disk space, network bandwidth, interrupt requests, system calls, energy, number of nodes, or number of racks that the first program is expected to consume when the first program executes in response to being invoked by the workload object.

5. The method of claim 1, wherein a first prediction for a first program represented by a first program identifier extracted from the workload object includes a range of predictions indicating two or more amounts of consumption of the resource by the first program when the first program executes in response to being invoked by the workload object.

6. The method of claim 1, wherein the trained prediction model is a sequence-to-sequence mapping model.

7. The method of claim 1, further comprising:
extracting a memory capacity value from the workload object, wherein one prediction is based, at least in part, on the memory capacity value and one of the program identifiers extracted from the workload object.

8. The method of claim 1, further comprising:
extracting a dataset capacity value from the workload object, wherein one prediction is based, at least in part, on the dataset capacity value and one of the program identifiers extracted from the workload object.

9. The method of claim 1, further comprising:
providing program identifiers of workload training data as inputs to an encoder of an untrained prediction model;
providing resource consumption values from resource consumption training data as output of a decoder of the untrained prediction model; and
training the untrained prediction model based, at least in part, on the resource consumption values and the program identifiers of the workload training data to create the trained prediction model.

10. A non-transitory computer readable medium comprising program code that is executable by a computer system to perform operations comprising:
obtaining workload training data and corresponding resource consumption training data, wherein the workload training data includes first program identifiers representing first programs previously invoked in a first order by a computing system;
providing the first program identifiers in the first order as inputs to an encoder of a prediction model that is to be trained;
providing resource consumption values from the resource consumption training data as outputs of a decoder of the prediction model; and
training the prediction model to translate second program identifiers in a second order to predictions related to amounts of consumption of a resource by second programs corresponding to the second program identifiers identified in a new workload object to be executed by the computing system.

11. The non-transitory computer readable medium of claim 10, wherein the workload training data includes an existing workload object previously executed on the computing system.

12. The non-transitory computer readable medium of claim 11, wherein the program code is executable by the computer system to perform further operations comprising:
parsing the existing workload object of the workload training data to identify the first program identifiers.

13. The non-transitory computer readable medium of claim 10, wherein the resource is related to a process time, memory usage, disk space, network bandwidth, interrupt requests, system calls, energy, number of nodes, or number of racks.

14. The non-transitory computer readable medium of claim 10, wherein the resource consumption training data includes a respective value for each program corresponding to one of the first program identifiers provided as inputs to the encoder of the prediction model, the respective value for each program indicating an amount of consumption of the resource by that program.

15. The non-transitory computer readable medium of claim 14, wherein the respective value for each program is based on a measurement captured during a previous execution of the first programs in the first order.

16. The non-transitory computer readable medium of claim 10, wherein the program code is executable by the computer system to perform further operations comprising:
providing a parameter from the workload training data as an input to the encoder of the prediction model, wherein the training is based, in part, on the parameter being associated with one of the first program identifiers.

17. The non-transitory computer readable medium of claim 16, wherein the parameter is a memory capacity or a dataset capacity.

18. The non-transitory computer readable medium of claim 10, wherein the program code is executable by the computer system to perform, subsequent to training the prediction model to become a trained prediction model, further operations comprising:
receiving the new workload object to be evaluated;
extracting the second program identifiers from the new workload object;
providing the extracted second program identifiers to the encoder of the prediction model; and
generating, by the decoder of the prediction model, predictions related to consumption of the resource, the predictions corresponding respectively to the extracted second program identifiers.

19. An apparatus comprising:
a processor; and
a memory for storing instructions that are executable by the processor to:
provide first program identifiers corresponding to first programs in a particular order as inputs to an encoder of a prediction model to be trained;
provide, as outputs of a decoder of the prediction model, first values indicating an amount of consumption of a resource by the first programs during a previous execution of the first programs in the particular order;
train the prediction model based, at least in part, on the first program identifiers and the first values indicating the amount of consumption of the resource; and
subsequent to training the prediction model:
provide second program identifiers as inputs to the encoder; and
translate, by the prediction model, the second program identifiers to second values indicating a predicted amount of consumption of the resource by second programs corresponding to the second program identifiers.

20. The apparatus of claim 19, wherein the resource is related to one of process time, memory usage, disk space, network bandwidth, interrupt requests, system calls, energy, number of nodes, or number of racks.
